(19) United States
(12) Patent Application Publication
(10) Pub. No.: US 2013/0014723 A1
(43) Pub. Date: Jan. 17, 2013

(54) METHOD FOR THE PRODUCTION OF A PISTON FOR AN INTERNAL COMBUSTION ENGINE AND PISTON FOR AN INTERNAL COMBUSTION ENGINE

(71) Applicant: Gerhard BUCHER, Eppingen (DE)

(72) Inventor: Gerhard BUCHER, Eppingen (DE)

(73) Assignee: MAHLE International GmbH, Stuttgart (DE)

(21) Appl. No.: 13/225,671

(22) Filed: Sep. 6, 2011

(30) Foreign Application Priority Data
Jul. 12, 2011 (DE) 10 2011 107 659.3

(51) Int. Cl. F02F 3/00; B23P 15/10

(52) U.S. Cl. 123/193.6; 29/888.043

(57) ABSTRACT

A method for the production of a piston for an internal combustion engine, composed of at least two components, each of which has at least one corresponding joining surface, has the following method steps: a) pre-working the at least two components, at least in the region of the joining surfaces; b) covering at least a part of the surface of at least one component with at least one covering medium; c) assembling the at least two components; d) connecting the at least two components along their corresponding joining surfaces, by means of beam welding, to produce a piston blank; e) removing the at least one covering medium and any excess weld material adhering to it; and f) machining the piston blank to produce a finished piston.

### CROSS REFERENCE TO RELATED APPLICATIONS

Applicant claims priority under 35 U.S.C. §119 of German Application No. 10 2011 107 659.3 filed Jul. 12, 2011, the disclosure of which is incorporated by reference.

### BACKGROUND OF THE INVENTION

1. Field of the Invention

The present invention relates to a method for the production of a piston for an internal combustion engine, composed of at least two components, each of which has at least one corresponding joining surface. The present invention furthermore relates to a piston that can be produced using such a method.

2. The Prior Art

In beam welding, excess weld material regularly occurs, generally in the form of weld beads or weld splashes. In the following, the term “weld beads” is used to refer to all forms of excess weld material.

In the production of a piston via beam welding, there is the risk that weld beads adhere to the piston. It is particularly disadvantageous if the weld beads enter the cooling channel and take hold there. During engine operation, the weld beads can come loose again and get into the cooling oil and thus into the cooling oil circuit and the lubrication oil circuit. In this case, the internal combustion engine would suffer irreparable harm.

### SUMMARY OF THE INVENTION

It is therefore an object of the present invention to provide a method for the production of a piston that prevents the exit of weld beads into the oil circuit during engine operation.

This object is accomplished by a method having the following steps:

a) pre-working the components, at least in the region of the joining surfaces;

b) covering at least a part of the surface of at least one component with at least one covering medium;

c) assembling the components;

d) connecting the components along their corresponding joining surfaces, by means of beam welding, to produce a piston blank;

e) removing the at least one covering medium and any excess weld material adhering to it; and

f) machining the piston to finish it.

The object of the present invention is furthermore a piston for an internal combustion engine that can be produced according to the method according to the invention and thus, in the end result, has at least two components connected with one another by means of beam welding and, at the same time, is free of weld beads.

Using the method according to the invention, when the at least two components are connected, weld beads accelerated out due to the beam welding do not adhere to the components. In particular, walls of a cooling channel that might be present can be kept free of weld beads. The weld beads either remain adhered to the covering medium or do not adhere at all. The covering medium is removed from the components again after beam welding. In the end result, a beam-welded piston is obtained that is free of weld beads.

Weld beads do not occur in the same frequency or thickness everywhere. For example, weld beads occur more frequently in those zones of the components that lie opposite the weld seams. These regions are supposed to be particularly protected.

The known pre-working of the components to be connected also includes cleaning and degreasing, in order to obtain a firm weld seam in step d).

It is practical if, in step b), the at least one covering medium is applied removed at least 1 mm from the edge of each joining surface, in order to prevent it from being damaged during beam welding or from impairing the quality, particularly the strength, of the weld seam. The joining surfaces themselves remain metallically shiny and uncoated.

The at least one component to be treated can be coated, at least in part, with at least one liquid covering medium, for example, in step b). Liquid covering mediums have the advantage that they can be applied particularly easily, for example by brushing them on, spraying them on, rolling them on, or imprinting them. Such covering mediums can have at least one liquid binder, for example, in which one or more active substances are contained, which are selected from the group comprising graphite, hexagonal boron nitride, polytetrafluoroethylene, as well as the mica group. For this purpose, however, a weld protection spray, for example, can also be used.

The at least one covering medium should be applied with a layer thickness of at least 100 μm, in order to guarantee effective protection of the at least one component and to reliably prevent weld material from remaining adhering to the surface of the at least one component.

The components to be coated with the liquid covering medium can be preheated to 50° C. to 80° C. before the covering medium is applied, in order to guarantee good adhesion of the at least one covering medium.

It is practical if the coated components are dried after step b), by heating them to 80° C. to 180° C., so that volatile components of the liquid covering medium are removed.

After beam welding, the at least one covering medium can be removed by means of high-pressure washing with a fluid at a pressure of up to 1000 bar. In this connection, at least one abrasive compound can is added to the fluid, in order to reinforce the effect of the washing process. With the at least one covering medium, weld beads adhering to it are also removed.

Supplementally or alternatively to this, the at least one covering medium can be removed by means of deburring, vibratory finishing, vibratory machining, or abrasive flow machining. In this connection, the use of a fluid is not absolutely necessary, so that an additional drying step might be eliminated.

For example, a protective film in the form of a graphite film and/or a protective woven fabric made of graphite fiber and/or a protective woven fabric made of ceramic fibers such as aluminum oxide, silicon oxide, mullite, or aluminum silicate, for example, can also be used, for example laid onto or glued onto the component. In order to guarantee reliable protection of the components from weld material, the protective film should preferably have a thickness of 0.3 mm to 0.5 mm, or the protective woven fabric should preferably have a thickness of 1.0 mm to 2.0 mm, respectively. After beam welding, the protective film or the protective woven fabric can be pulled off, together with any weld beads adhering to it, or can be removed out of a cooling channel, if applicable, through the cooling oil entry opening or cooling oil exit opening.

Heat-resistant twines, cords and/or ropes made of graphite and/or ceramic fiber, for example twisted or braided, can serve as a covering medium. If a cooling channel is supposed to be covered with this, it is practical if the channel is filled with the covering medium at least in its width. If one lets one end of the twine, the cord or the rope project out of a cooling oil entry opening or cooling oil exit opening of the cooling channel, the covering medium, together with weld beads adhering to it, can be removed by simply pulling it out after beam welding.

The protective film, the protective woven fabric, or the twine, the cord and/or the rope can also be broken up before being removed, and flushed out or blown out, if necessary.

The at least two components to be connected can be tacked together before beam welding. Furthermore, at least one component can be shrunk-fit onto another component. In this way, the components are fixed in place relative to one another, in terms of their position.

The at least two components can be connected particularly by means of electron beam welding or laser welding. The use of a CO₂ laser is preferred, because comparatively small amounts of weld beads are formed with it.

Before beam welding, the components to be connected can be preheated to 400° C. to 550° C., in order to obtain a particularly strong and reliable weld connection and to avoid cracks.

After beam welding and the removal of the covering medium, the resulting piston blank can be blown off, or its cooling channel can be blown out, in order to remove residues of covering medium and weld material. After high-pressure washing with a fluid, a drying process can follow. In every case, it is practical to protect the piston blank against corrosion, in known manner.

The piston blank should furthermore be inspected for complete removal of weld beads. The inspection of a cooling channel that might be present can be undertaken using an endoscope, for example.

The machine finishing of the piston blank, which is actually known, comprises a heat post-treatment known to a person skilled in the art, depending on the material used for the components, if applicable.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a sectional view of a first embodiment of a piston according to the invention;

FIG. 2 shows a sectional view of another embodiment of a piston according to the invention;

FIG. 3 shows a sectional view of another embodiment of a piston according to the invention;

FIG. 4 shows an exploded view of the embodiment according to FIG. 1, before the components to be connected are assembled; and

FIG. 5 shows the embodiment according to FIG. 1 after beam welding.

### DETAILED DESCRIPTION OF THE PREFERRED EMBODIMENT

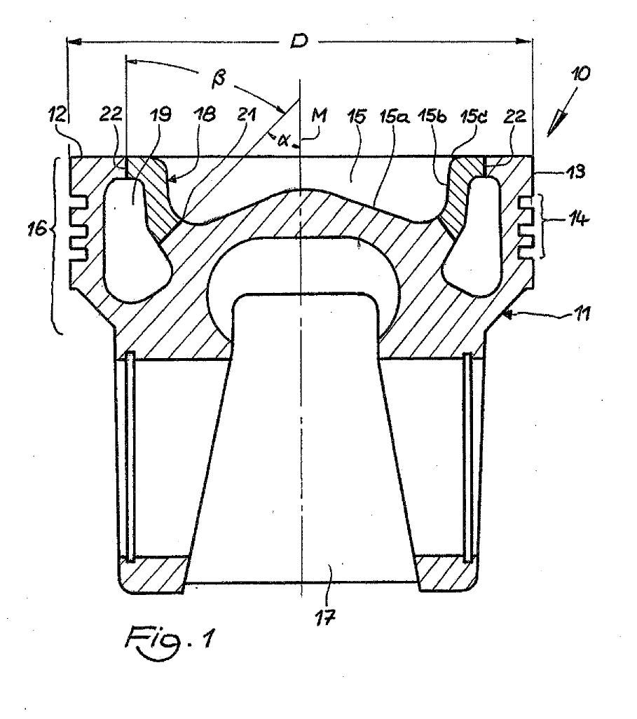

Referring now in detail to the drawings, FIG. 1 shows a first embodiment of a piston 10 according to the invention. Piston 10 has a component 11 configured as a piston base body, which is produced, for example, from an annealed steel such as 42CrMo4 or an AFP steel such as 38MnSiVS6, for example, or a bainitic AFP steel alloyed with 0.4 wt.-% molybdenum. Component 11 has a part of a piston crown 12, a circumferential top land 13, as well as a circumferential ring belt 14 having ring grooves for accommodating piston rings (not shown). Component 11 furthermore has the bottom 15a of a combustion bowl 15. Component 11 thus forms an essential part of piston head 16 of piston 10. Component 11 furthermore forms piston skirt 17 of piston 10 according to the invention, in known manner.

The piston according to the invention furthermore has a component 18 configured as an insert that forms the entire bowl wall 15b as well as bowl edge region 15c of combustion bowl 15, and furthermore part of piston crown 12. Component 18 preferably consists of a particularly high-strength material. For this purpose, an annealed steel or AFP steel can be used for the piston base body 11. Furthermore, a steel that is resistant to high elevated temperatures, corrosion-resistant, and heat-resistant is suitable. Valve steels such as, for example, CrSi steel (X45CrSi93), Chromo193 steel (X85CrMoV182), 21-4 N steel (X53CrMnNiN219), 21-2 steel (X55CrMnNiN208), and materials such as Nimonic80A (NiCr20TiAl), ResisTEL, or VMS-513 are particularly suitable.

Components 11, 18 form a circumferential outer cooling channel 19. Cooling channel 19 runs at the level of ring belt 14, on the one hand, and at the level of bowl wall 15b of combustion bowl 15, on the other hand.

Component 18 has a lower circumferential joining surface that forms a lower weld seam 21 with a circumferential joining surface on component 11 that encloses bottom 15a of the combustion bowl 15. Lower weld seam 21 has a length of 3.5% to 5.5% of piston diameter D, and encloses an acute angle α with the piston center axis M. The lower weld seam 21 therefore runs radially toward the outside, proceeding from bowl wall 15b, and downward (in the direction of piston skirt 17), and ends in cooling channel 19, in the region of the cooling channel bottom.

Component 18 furthermore has an upper circumferential joining surface that forms an upper weld seam 22 with a circumferential joining surface on component 11, in the region of top land 13. Upper weld seam 22 has a length of 4.5% to 6.0% of the piston diameter D. Upper weld seam 22 runs from the cooling channel ceiling to piston crown 12 and parallel to the piston center axis M, and encloses an acute angle β with the lower weld seam 21.

Lower weld seam 21 and upper weld seam 22 are produced by beam welding and are disposed in such a manner that they are accessible to a tool for beam welding. During beam welding, excess weld material enters cooling channel 19, for example in the form of weld splashes, and preferentially collects, for example in the form of weld beads, in a region of cooling channel 19 that lies opposite weld seams 21, 22.

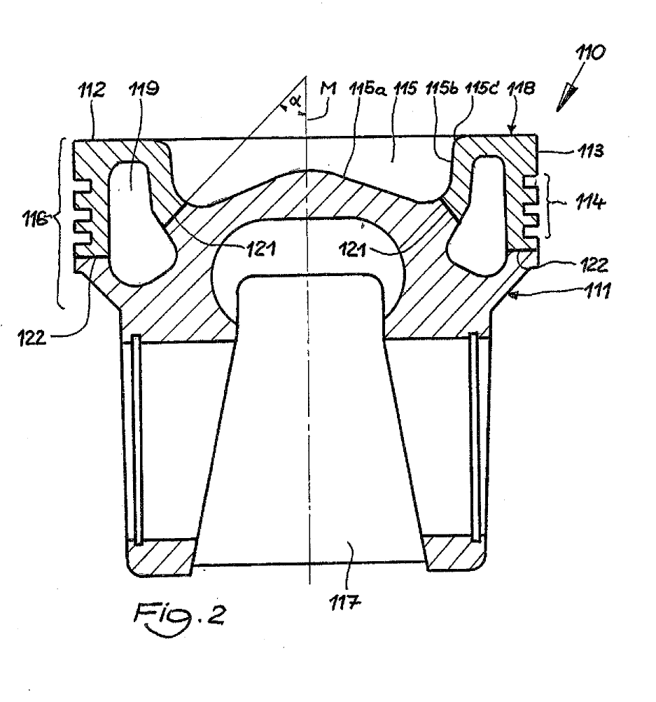

FIG. 2 shows another embodiment of a piston 110 according to the invention. Piston 110 has a component 111 configured as a piston base body, which is produced from a material such as that described for component 11 according to FIG. 1, for example. Component 111 has bottom 115a of a combustion bowl 115. Component 111 furthermore forms piston skirt 117 of piston 110 according to the invention, in known manner.

The piston according to the invention furthermore has a component 118 that forms the entire bowl wall 115b as well as bowl edge region 115c of combustion bowl 115, and furthermore piston crown 112, top land 113, and ring belt 114. Component 118 preferably consists of a particularly high-strength material, such as that described for component 18 according to FIG. 1.

Components 111, 118 form a circumferential outer cooling channel 119. Cooling channel 119 runs at the level of ring belt 114, and at the level of bowl wall 115b of combustion bowl 115.

Component 118 has an inner circumferential joining surface that forms an inner weld seam 121 with a circumferential joining surface on component 111, which surface encloses the bottom 115a of combustion bowl 115. Inner weld seam 121 has a length of 3.5% to 5.5% of piston diameter D, and encloses an acute angle with piston center axis M. Inner weld seam 121 therefore runs radially toward the outside, proceeding from bowl wall 115b, and downward (in the direction of piston skirt 117), and ends in cooling channel 119, in the region of the cooling channel bottom.

Component 118 furthermore has an outer circumferential joining surface that forms an outer weld seam 122 with a circumferential joining surface 111 below ring belt 114.

Inner weld seam 121 and outer weld seam 122 are produced by beam welding and are disposed in such a manner that they are accessible to a tool for beam welding. During beam welding, excess weld material enters cooling channel 119, for example in the form of weld splashes, and usually collects, for example in the form of weld beads, in a region of cooling channel 119 that lies opposite weld seams 121, 122.

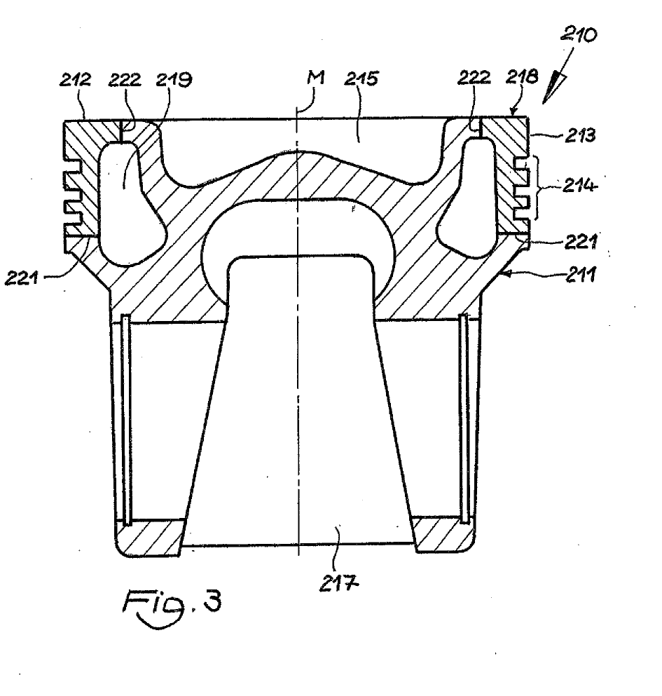

FIG. 3 shows another embodiment of a piston 210 according to the invention. Piston 210 has a component 211 configured as a piston base body, which is produced from a material such as that described for component 11 according to FIG. 1, for example. Component 211 has a part of piston crown 212 as well as a combustion bowl 215. Component 211 furthermore forms piston skirt 217 of piston 210 according to the invention, in known manner.

The piston according to the invention furthermore has a component 218, configured in ring shape, that forms part of piston crown 212, a circumferential top land 213, as well as a circumferential ring belt 214 having ring grooves for accommodating piston rings (not shown). Component 218 preferably consists of a particularly high-strength material, such as that already described for component 18 according to FIG. 1.

Components 211, 218 form a circumferential outer cooling channel 219. Cooling channel 219 runs at the level of ring belt 214, on the one hand, and at the level of the bowl wall of combustion bowl 215, on the other hand.

Component 218 has a lower circumferential joining surface below ring belt 214, that forms a lower weld seam 221 with a lower circumferential joining surface on component 211. Component 218 furthermore has an upper circumferential joining surface in the region of top land 213, which surface forms an upper weld seam 222 with an upper circumferential joining surface in the region of combustion bowl 215 on component 211. Upper weld seam 222 runs from the cooling channel ceiling to piston crown 212, as well as parallel to piston center axis M.

Lower weld seam 221 and the upper weld seam 222 are produced by beam welding and are disposed in such a manner that they are accessible to a tool for beam welding. During beam welding, excess weld material enters cooling channel 219, for example in the form of weld splashes, and usually collects, for example in the form of weld beads, in a region of cooling channel 219 that lies opposite weld seams 221, 222.

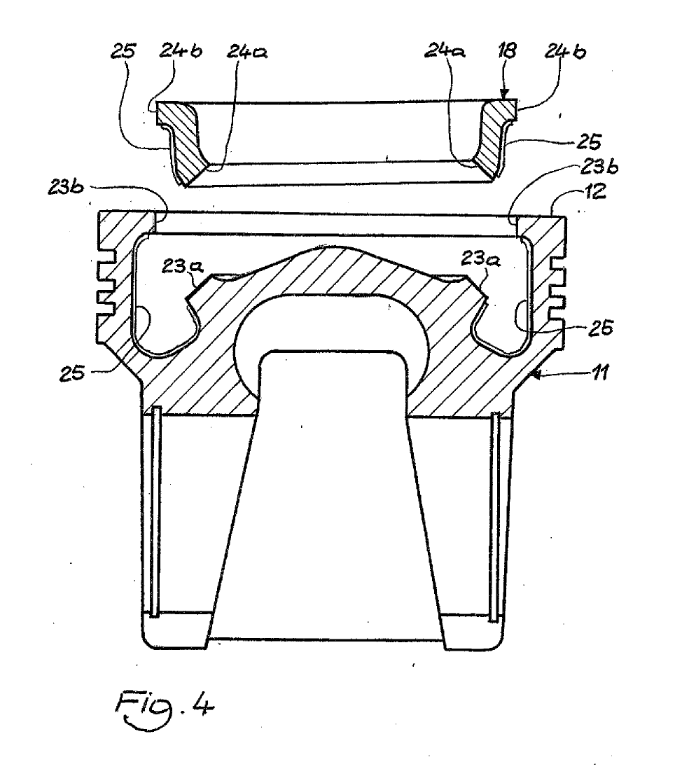

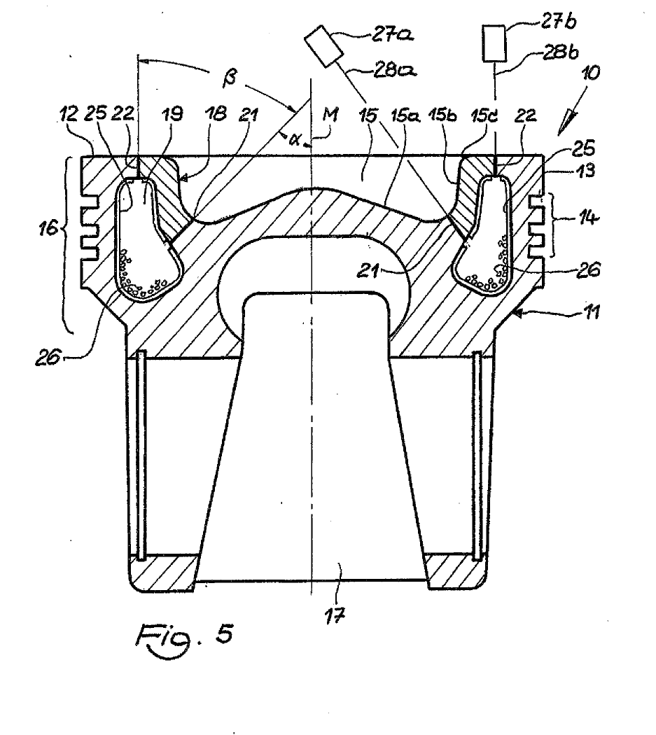

An embodiment of the method according to the invention, for production of a piston according to the invention, for example the piston 10, 110, 210, will be described in greater detail in the following, using a piston 10 according to FIG. 1 as well as using FIGS. 4 and 5. Of course, the method described in the following applies analogously for the production of pistons 110, 210 according to FIGS. 2 and 3, respectively.

First, components 11, 18 to be connected are pre-worked. In particular, the circumferential joining surfaces 23a, 23b of the component 11 as well as the corresponding circumferential joining surfaces 24a, 24b of the component 18, the regions of cooling channel 19 (see FIG. 5), piston crown 12, and the outer contour are pre-lathed. If necessary, a one-pass can be lathed in, in order to securely fix in place components 11, 18 that are to be connected, against one another. Making available cleanly lathed joining surfaces 23a, 23b; 24a, 24b as well as inner and outer contours serves to prepare for weld seams 21, 22 (see FIG. 5), in order to obtain a firm and reliable weld connection. Furthermore, joining surfaces 23a, 23b; 24a, 24b should be cleaned and degreased, for example with acetone.

In the exemplary embodiments shown in FIGS. 1 to 3, covering medium 25 provided according to the invention is applied in the region of the cooling channel 19, because joining surfaces 23a, 23b; 24a, 24b are positioned in such a manner that weld beads 26 enter into the region of cooling channel 19 during the welding process (see FIG. 5). Covering medium 25 that is used should be applied so that it is removed from each edge of the joining surfaces 23a, 23b; 24a, 24b at a distance of at least 1 mm, so that it is not damaged during the later welding process, and that the quality, particularly the strength, of weld seams 21, 22 (see FIG. 5) is not impaired. The covering medium can be applied in thickened form in those regions that lie opposite joining surfaces 23a, 23b; 24a, 24b, because the most weld beads impact in these regions during the subsequent welding process.

If a liquid covering medium 25 is used, the components to be connected can be preheated, in advance, to 50° C. to 80° C., in order to achieve good adhesion of the covering medium 25 on the components 11, 18. The liquid covering medium 25 can be sprayed on, brushed on, rolled on, or printed on, for example by means of screen printing. The application can be repeated multiple times, if necessary, until the desired layer thickness, preferably at least 100 μm, is reached. After application of the liquid covering medium 25, components 11, 18 to be connected can be dried at a temperature of 80° C. to 180° C., in order to remove the volatile components of covering medium 25.

Suitable liquid covering media 25 are, for example, a dispersion of superfine semi-colloidal graphite in water (available as a mold coating under the product name “Hydrokollag” from the company Acheson Colloiden B.V., Netherlands), hexagonal boron nitride, mica, or tetrafluoropolyethylene (Teflon) slurried up in water or an organic binder or sodium silicate, as well as commercially available weld protection sprays (available, for example, under the trade names “Antiperr 2000” or “Antiperl 2000” from the company Hintz Marketing GmbH, Rheinmünster).

When using a solid covering medium 25, this is laid onto or glued onto the regions of the components to be connected, on which weld beads 26 impact during the welding process, in other words in the region of cooling channel 19.

Suitable solid covering media 25 are, for example, films made of graphite (for example available under the trade name “Sigraflex” from the company SGL Carbon SE, Wiesbaden), preferably having a thickness of 0.3 mm to 0.5 mm. Furthermore, protective woven fabrics made of graphite fibers or ceramic fibers, for example aluminum silicate fibers, are suitable (available under the trade name “Fiberfrax” from Unifrax GmbH, Düsseldorf), with a preferred thickness of 1 mm to 2 mm.

Heat-resistant twines, cords, or ropes made of ceramic fiber, twisted or braided, can also serve as covering media 25. It is practical if, in the exemplary embodiment, they are selected to be so thick that they fill the region of the cooling channel 19 at least in its width. If one lets one end of the twine, the cord, or the rope project out of a cooling oil entry opening or cooling oil exit opening of the cooling channel 19, then the twine can be removed after beam welding simply by pulling it out.

After application of the covering medium 25, component 18 is shrunk-fit onto component 11 in known manner, in that component 11 is heated to 180° C. to 200° C., component 18 is set on, and component 11 is subsequently cooled. Shrink-fitting should take place without a gap, as much as possible, in other words joining surfaces 23a, 23b; 24a, 24b should lie firm and flat on one another, so that during the later welding process, smooth, firm weld seams 21, 22 are obtained. In addition, components 11, 18 to be connected can be tacked together along their joining surfaces 23a, 23b; 24a, 24b, at points or circumferentially, at a low welding depth.

Components 11, 18 are connected in known manner, by means of laser welding, using at least one commercially available CO₂ laser 27a, 27b. For this purpose, the components 11, 18 are heated, in advance, to 400° C. to 550° C. In the selection of covering medium 25, in the exemplary embodiment, care should therefore be taken to ensure that it is stable in this temperature range.

When using a CO₂ laser 27a, 27b, particularly few weld beads 26 occur. Of course, other lasers, such as solid body lasers, are also suitable. Components 11, 18 can also be connected with one another by electron beam welding. The required power of the welding tool is dependent on the materials used for components 11, 18 and on the length of weld seams 21, 22 to be formed. The required parameters can be set in known manner by a person skilled in the art. No additional welding material is required.

Joining surfaces 23a, 23b; 24a, 24b should be laid in such a manner that weld seams 21, 22 in finished piston 10 are disposed in those regions in which as little stress as possible occurs during engine operation, in order to reduce the risk of crack formation in the region of weld seams 21, 22. Of course, joining surfaces 23a, 23b; 24a, 24b must also be laid in such a manner that they are accessible for the weld beams, which are laser beams 28a, 28b in this embodiment. The position of joining surfaces 23a, 23b; 24a, 24b therefore generally represents a compromise between the stability of finished piston 10 and the requirements of the production method. Slanted joining surfaces 23a, 24a and weld seams 21, respectively, serve for automatic centering of components 11, 18 relative to one another, in known manner.

Corresponding deliberations apply analogously, of course, also for pistons 110, 210 according to FIGS. 2 and 3, respectively.

In this embodiment, component 18 was laser-welded to component 11 by two CO₂ lasers 27a, 27b, using two butt seams 21, 22.

After the welding process, covering medium 25, together with any weld material adhering to it, was removed from the resulting piston blank 10′. If a liquid covering medium 25 was used to produce a coating on components 11, 18, this can be done by means of high-pressure washing with water or oil, at a pressure of up to 1000 bar. In order to increase the effect of the washing process, an abrasive such as diamond, corundum, silicon carbide, or hard-cast blasting medium can be added to the water or oil. Furthermore, at least one wetting agent can be added to the water, to reduce the surface tension and thus to improve the cleaning effect.

The covering medium can also be removed by means of deburring, for example with a deburring system composed of steel balls in a circulated fluid (available under the trade name “Pinflow” from the company TDK Maschinenbau GmbH, Neumünster).

Furthermore, known vibratory finishing methods, using abrasives such as mineral blasting media (diamond, corundum, silicon carbide) or granular, i.e. hard-edged hard-cast blasting media are suitable for removing adhering covering medium 25. In the exemplary embodiment, the abrasives are filled into cooling channel 19 and covering medium 25 adhering in there is removed by means of a vibratory finishing method, particularly vibratory grinding or centrifugal vibratory machining. The vibratory finishing methods can work dry or by means of a suspension, for example an aqueous suspension.

Finally, abrasive flow machining (for example from the company Micro Technica Technologies GmbH, Kornwestheim) can also be used to remove adhering covering medium 25. In this connection, a highly viscous polymer plastic is used, in which abrasives are embedded. In this embodiment, the mass is moved in cooling channel 19 under pressure, thereby abrasively removing covering medium 25.

If a covering medium 25 in the form of a protective film, a protective woven fabric, or a twine, a cord and/or a rope was used, this can be removed from cooling channel 19 through the oil entry opening or oil exit opening. For example, a thread of the protective woven fabric or of a twine, a cord, or a rope can project out of the opening, during the entire production process, and can serve as a handle. Solid covering medium 25 can also be mechanically broken down by an abrasive, and flushed out of the cooling channel 19, particularly if it was glued onto the component 11, 18.

It is recommended to blow out piston blank 10′ after covering medium 25 has been removed and/or to flush it wet and then dry it, in order to make sure that the covering medium and the weld beads have been completely removed. Afterwards, the piston blank 10′ should be carefully protected against corrosion.

In the exemplary embodiment, it is finally recommended to inspect cooling channel 19 by an endoscope, to check for complete removal of the weld material.

Piston blank 10′ is finally machined, in known manner, to produce finished piston 10. This includes, depending on the materials used, a heat post-treatment known to a person skilled in the art.

Accordingly, while only a few embodiments of the present invention have been shown and described, it is obvious that many changes and modifications may be made thereunto without departing from the spirit and scope of the invention.

What is claimed is:

1. A method for the production of a piston for an internal combustion engine, composed of at least two components, each said components having at least one corresponding joining surface, comprising the following method steps:
a) pre-working the at least two components, at least in a region of the joining surfaces;
b) covering at least a part of a surface of at least one of the components with at least one covering medium;
c) assembling the at least two components;
d) connecting the at least two components along their corresponding joining surfaces, by means of beam welding, to produce a piston blank;
e) removing the at least one covering medium and any excess weld material adhering to the covering medium; and
f) machining the piston blank to produce a finished piston.

2. The method according to claim 1, wherein in step b), the at least one covering medium is applied at least 1 mm removed from an edge of each joining surface.

3. The method according to claim 1, wherein in step b), the step of covering comprises coating the at least one component with at least one liquid covering medium, by means of brushing on, spraying on, rolling on, or imprinting.

4. The method according to claim 3, wherein the covering medium comprises at least one liquid binder in which one or more active substances are contained, said active substances being selected from the group consisting of graphite, hexagonal boron nitride, polytetrafluoroethylene, and mica.

5. The method according to claim 3, wherein in step b), a weld protection spray is used.

6. The method according to claim 3, wherein in step b), the at least one covering medium is applied with a layer thickness of at least 100 μm.

7. The method according to claim 3, wherein before step b), the components to be coated with the covering medium are preheated to 50° C. to 80° C.

8. The method according to claim 3, wherein after step b), the coated components are dried by being heated to 80° C. to 180° C.

9. The method according to claim 3, wherein in step e), the covering medium is removed by high-pressure washing with a fluid at a pressure of up to 1000 bar.

10. The method according to claim 9, wherein in step e), at least one abrasive is added to the fluid.

11. The method according to claim 3, wherein in step e), the covering medium is removed by deburring, vibratory finishing, vibratory machining, or abrasive flow machining.

12. The method according to claim 1, wherein the covering medium is a protective film in the form of a graphite film, a protective woven fabric made of graphite fiber, a protective woven fabric made of ceramic fiber, a rope made of graphite fiber or ceramic fiber, a twine made of graphite fiber or ceramic fiber, or a cord made of graphite fiber or ceramic fiber.

13. The method according to claim 12, wherein the covering medium is a protective film having a thickness of 0.3 mm to 0.5 mm or a protective woven fabric having a thickness of 1.0 mm to 2.0 mm.

14. The method according to claim 12, wherein in step e), the covering medium is broken up before being removed.

15. The method according to claim 1, wherein in step c), the at least two components are tacked, or at least one component is shrunk-fit onto one of the other components.

16. The method according to claim 1, wherein in step d), the at least two components are connected by means of electron beam welding or laser welding.

17. The method according to claim 16, wherein in step d), a CO₂ laser is used.

18. The method according to claim 16, wherein before step d), the components to be connected are preheated to 400° C. to 550° C.

19. The method according to claim 1, wherein the piston blank is blown off or dried, as well as protected against corrosion, after step e).

20. The method according to claim 1, wherein the piston blank is inspected for complete removal of excess weld material, after step e).

21. A piston for an internal combustion engine produced by means of a method according to claim 1.

22. A piston for an internal combustion engine, comprising at least two components which are connected with one another by means of beam welding, wherein the piston is free of excess weld material adhering to the piston.
